(19) United States
(12) Patent Application Publication
(10) Pub. No.: US 2021/0022299 A1
(43) Pub. Date: Jan. 28, 2021

(54) WATERPROOF TABLE PLANTER

(71) Applicant: Dustin Anthony, San Diego, CA (US)

(72) Inventor: Dustin Anthony, San Diego, CA (US)

(21) Appl. No.: 16/933,698

(22) Filed: Jul. 20, 2020

Related U.S. Application Data
(60) Provisional application No. 62/877,688, filed on Jul. 23, 2019.

(51) Int. Cl. A01G 9/02; A47B 13/12

(52) U.S. Cl. CPC A01G 9/02; A47B 2200/0084; A47B 13/12

(57) ABSTRACT

A waterproof table planter having a planter supported on table legs and a tabletop supported above the planter on columns. The planter includes a lower main body and the waterproof liner supported within the lower main body, the liner defining a trough with the floor and side walls for holding soil or other plant growth medium. The tabletop may be transparent in order to see plants growing within the trough. The tabletop is supported on the columns using elastomeric bumpers or suction cups to enable easy removal for tending to the plants. The columns may be positioned directly over the table legs and connected through the floors of the lower main body and liner of the planter. A drain bulkhead extends through the floor of the planter to a drain valve for draining the trough.

### RELATED APPLICATIONS

The present application claims priority under 35 U.S.C. 119 to U.S. Provisional Application Ser. No. 62/877,688, filed Jul. 23, 2019, the contents of which are expressly incorporated herein by reference.

### FIELD OF THE INVENTION

The present invention is directed to a table planter and, in particular, to a table with a waterproof planter suspended under a glass top.

### BACKGROUND OF THE INVENTION

Various decorative planters built not furniture are known. For instance, the Ecoo Chair is a clear curved polycarbonate cylinder filled with a terrarium that functions as a chair (https://inhabitat.com/terrarium-chair-fiore-arcangelos-ecoo-chair-is-filled-with-plants/). The Living Table, previously available from Habitat Horticulture, positions a wooden planter box under a glass tabletop (http://livingtable.habitathorticulture.com/about).

Despite some examples of table planters, there remains a need for a relatively inexpensive assembly of a table planter that is structurally strong, easy-to-assemble, and waterproof so as to be suitable for placement in all rooms.

### SUMMARY OF THE INVENTION

The present application provides a table planter that is structurally strong, easy-to-assemble, and waterproof so as to be suitable for placement in all rooms. The table is especially useful for holding and displaying plants, and due to that fact that it is watertight it also may host aquatic plants or even fish.

In one embodiment, a waterproof table planter, comprise a planter having a lower main body having a floor and side walls on which rests a waterproof liner, the liner defining a trough having a floor and side walls for containing soil or other plant growth medium. A tabletop is spaced above the planter by a plurality of columns that are fixed to the floor of the liner, and further including seals between the columns and liner to prevent leakage therebetween. A plurality of generally vertical table legs fixed to an underside of the planter support the planter horizontally above a ground surface.

There may be the same number of columns as table legs, and each column is located directly above a table leg and secured thereto. For instance, each table leg may include a vertical bolt extending upward through aligned holes in the lower main body and liner, wherein each column has a female threaded bore at a lower end that threateningly engages the vertical bolt in one of the table legs. Furthermore, each table leg may further include a horizontal flange at an upper end from which the vertical bolt extends upward, each horizontal flange having through holes for receiving fasteners for securing the table leg to an underside of the lower main body.

The planter and tabletop may have rectangular horizontal peripheries, and the planter has a trapezoidal vertical section with the side walls of both the lower main body and liner angling outward from the respective floors. The liner may be a hard plastic or acrylic.

The waterproof table planter may further include a drain bulkhead extending through sealed holes in both the liner and lower main body, and a drain valve fastened to the drain bulkhead below the planter. The drain valve preferably has a lower fastener to which a drain tube may be connected.

A further understanding of the nature and advantages of the invention will become apparent by reference to the remaining portions of the specification and drawings.

### BRIEF DESCRIPTION OF THE DRAWINGS

Features and advantages of the present invention will become appreciated and become better understood with reference to the specification, claims, and appended drawings wherein:

FIG. 1 is an assembled perspective view of an exemplary construction of an elongated waterproof table planter of the present application filled halfway with plants and soil;

FIG. 2 is an exploded perspective view of an exemplary construction of the waterproof table planter;

FIG. 3A is a bottom plan view of one corner of a planter base showing holes for mounting a table leg, and FIG. 3B is a perspective view of a top end of one of the table legs;

FIG. 4 is a vertical sectional view through a bulkhead and drain valve that may be incorporated into the exemplary waterproof table planter;

FIG. 5 is a perspective view of the inside of the planter base showing a pair of threaded bolts extending upward therethrough from two of the table legs;

FIG. 6 is a perspective view of the inside of the planter base after placement of an inner waterproof liner and assembly of a vertical column above one of the table legs for supporting a tabletop;

FIGS. 7A and 7B are perspective views of the elongated waterproof table planter of FIG. 1 without plants;

FIG. 8A-8C are orthogonal views of the elongated waterproof table planter of FIGS. 7A and 7B;

FIGS. 9A and 9B are perspective views of a coffee table version of the waterproof table planter of the present application without plants;

FIG. 10A-10C are orthogonal views of the waterproof table planter of FIGS. 9A and 9B;

FIGS. 11A and 11B are perspective views of an end table version of the waterproof table planter of the present application without plants; and

FIG. 12A-12C are orthogonal views of the waterproof table planter of FIGS. 11A and 11B.

### DETAILED DESCRIPTION OF THE PREFERRED EMBODIMENTS

The table planter of the present application generally comprises a transparent tabletop supported over a waterproof planter which, in turn, is supported on table legs above the ground. More specifically, the waterproof planter comprises a structural base to which a plurality of table legs are secured. A waterproof pan or liner is positioned over or within the structural base and may be filled with soil for growing plants. Because the waterproof liner is sealed on its underside, the user may add water as needed without worry of leakage. Moreover, the waterproof liner is made of a material that is resistant to deterioration from moisture, and thus the structural base may be made of materials that generally must remain dry.

It should be understood that the size and shape of the table planter can vary greatly, and the exemplary embodiment of a rectangular table on four generally vertical legs is merely for illustration. For example, the table can be circular or oval or other irregular or geometric shape, and the table legs can be angled or curved and of varying heights and numbers.

Moreover, the materials used in the table planter also may vary. For example, although a solid glass tabletop is preferred for its transparency and hardness, a hard, transparent plastic or acrylic may also be used, in addition to tabletops that are not transparent or are not solid, such as a latticework. The waterproof liner is desirably a hard plastic or acrylic so as to resist deterioration. The structural base on which the waterproof liner rests is then preserved from contact with moisture, and can be formed of wood, metal, plastic, or generally any rigid material that is desired.

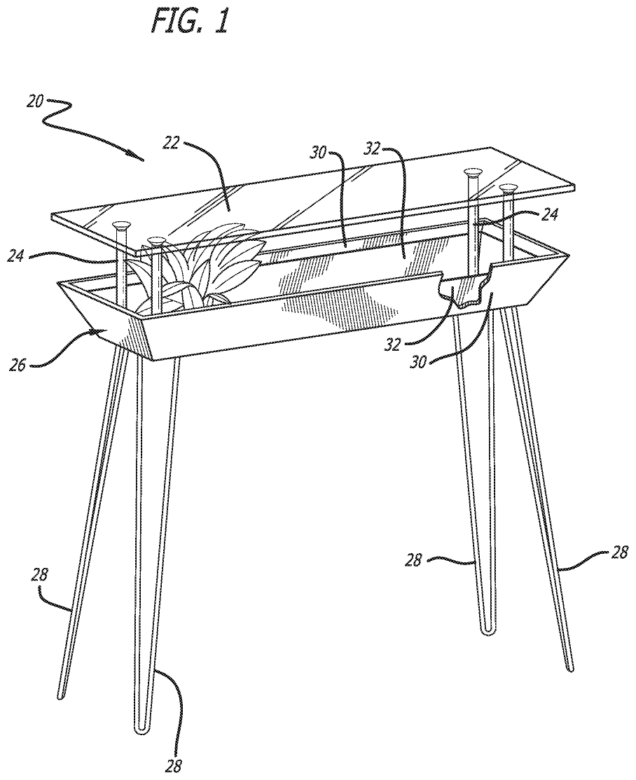

FIG. 1 is an assembled perspective view of an exemplary construction of the waterproof table planter 20 of the present application filled halfway with plants and soil. The waterproof table planter 20 comprises a tabletop 22 supported on a plurality of columns 24 above a waterproof planter 26. The planter 26 is, in turn, supported above the ground by a plurality of generally vertical table legs 28.

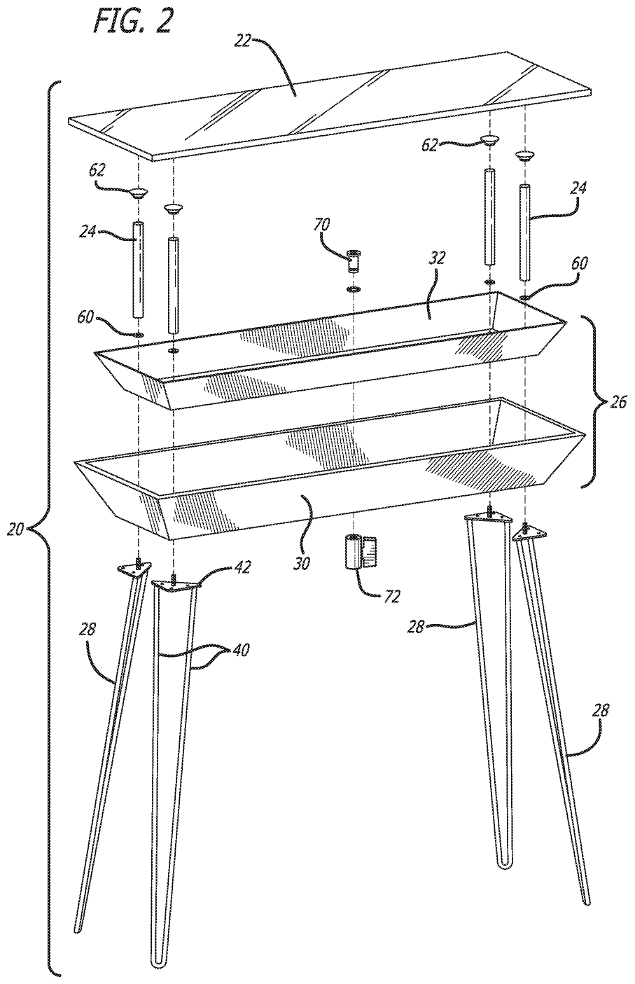

With reference to the exploded perspective view of FIG. 2, waterproof planter 26 includes a lower main body or base 30 on which rests a waterproof pan or liner 32. In the exemplary embodiment, the base 30 comprises a generally trapezoidal-shaped wooden basin, while the waterproof liner 32 may be a hard plastic or acrylic member of similar shape but of slightly reduced size. Preferably, the liner 32 fits closely within the base 30 so that their adjacent walls are in contact on all sides. In one embodiment, the waterproof liner 32 is formed by applying multiple coats of a thick epoxy resin to the inside of the base 30, either before or after holes are drilled through the base.

The waterproof pan or liner 32 has a floor and upwardly-extending walls surrounding a trough suitable for containing soil or other plant growth medium. The depth of the trough may vary, but is preferably between 4-8 inches depending on the variety of plant that will be grown.

The table legs 28 are shown as V-shaped rods 40 connected at their upper ends to a horizontal triangular flange 42 which are secured to the underside of the base 30. The rods 40 are angled with respect to the flange 42 so that the table legs 28 are splayed outward slightly. Again, the exemplary table legs 28 are just one of numerous possible designs, and may be straight or curved, single rod or multiple, etc.

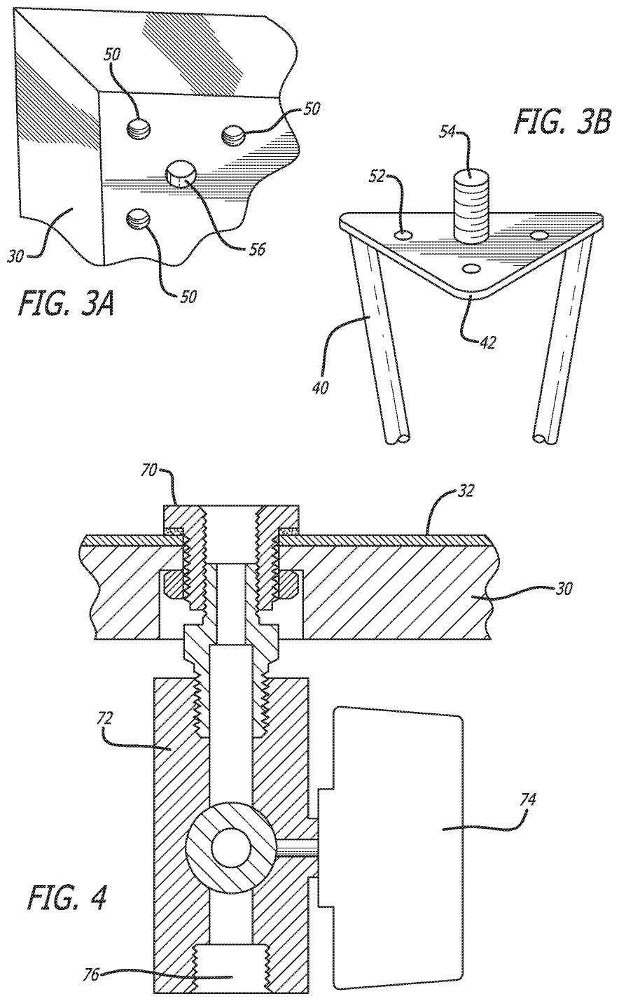

An exemplary construction technique will be explained with respect to FIG. 2 and FIGS. 3A-3B. Each corner of a planter base 30 includes holes 50 for mounting one of the table legs, as seen in FIG. 3A. In one embodiment, there are three such holes 50 formed in or through the bottom of the base 30 which receive fasteners that also passed through three holes 52 in each of the triangular flanges 42 of a table leg. Numerous fasteners may be used in this respect to hold the table legs 28 to the underside of the base 30, including inserting metallic anchors into the holes 50 in the base to receive screws or bolts passed from the underside through the holes 52 in the flanges 42.

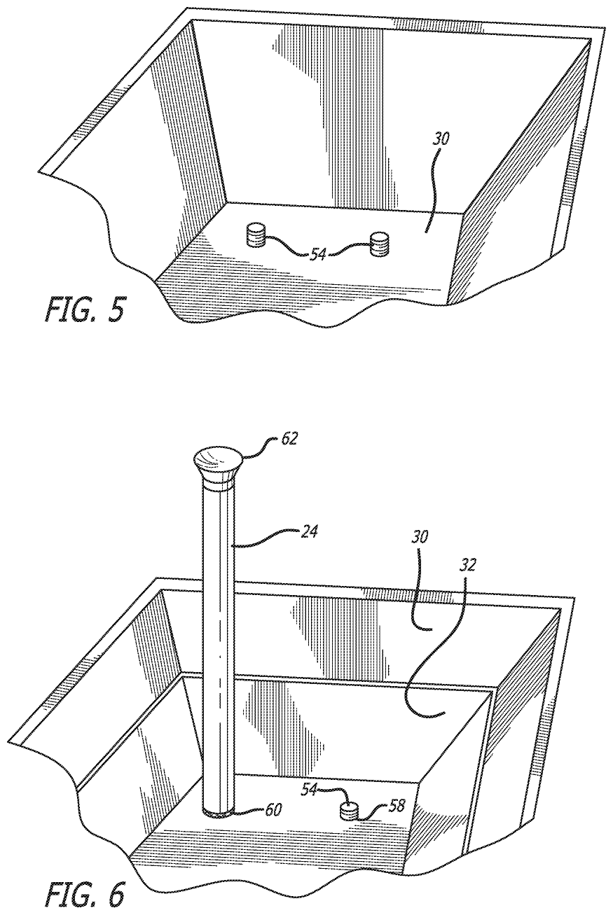

Each of the table legs 28, and in particular each of the triangular flanges 42, also has an upstanding bolt 54 which passes through a larger hole 56 in the planter base 30. With reference now to FIG. 5, a view of the inside of the planter base 30 shows a pair of the threaded bolts 54 extending upward therethrough from two of the table legs. FIG. 6 then shows placement of the inner waterproof liner 32 within the base 30. The liner 32 also has through holes 58 sized and positioned to receive the threaded bolts 54 therethrough. Subsequently, the vertical columns 24 for supporting the tabletop 22 are installed over the bolts 54. More particularly, a lower end of each of the vertical columns 24 desirably has a female threaded bore which mates with the bolts 54, though other fastening solutions may be used.

As seen in FIG. 2, resilient washers 60 are provided around the bolts 54 and between the waterproof liner 32 in the vertical columns 24 to seal the holes 56, 58 through the waterproof planter 26. The resilient washers 60 may be silicone, rubber, or other such water-resistant material. Seals other than the resilient washers 60 may be provided between the columns 24 and liner 32 to prevent leakage therebetween, such as gaskets, sleeves, a curable liquid fill, etc.

FIG. 2 also illustrates a plurality of elastomeric suction cups 62 that are positioned between the upper ends of the vertical columns 24 and the underside of the tabletop 22 to reduce relative movement therebetween. Suction cups 62 may be replaced with simple elastomeric bumpers or the like, with the advantage that the tabletop 22 can simply be pulled upward from its position on top of the columns 24 to access the trough defined by the waterproof planter 26 below. This enables a user to easily access the trough to initially distribute and then tend to the plants within the planter 26.

The alignment of the table legs 28 directly underneath, and indeed connected directly to, the columns 24 provides excellent structural support for the tabletop 22. Further, the relatively straightforward coupling of the legs 28 through the waterproof planter 26 to the columns 24 and, ultimately, the tabletop 22, makes the table planter easy-to-assemble, package and ship. The various components may be swapped out for different shapes, materials, styles, etc., since the entire assembly is modular. For example, the same coupling at the top of the legs 28 may be provided on curved, ornate legs that supports a more rounded table planter. Likewise, the columns 24 may be other than straight vertical elements so as to add various aesthetic touches.

FIG. 2 also illustrates a drain bulkhead 70 desirably fitted within another through bore (not shown) through the two parts of the waterproof planter 26. FIG. 4 is a vertical sectional view through the bulkhead 70 and a connected drain valve 72 with actuating handle 74 that may be incorporated into the exemplary waterproof table planter. Appropriate sealing washers are also used between the bulkhead 70 and the planter through bore. The drain valve 72 may have a lower fastener 76 to which a drain tube may be connected. In use, a drain tube may be connected and extended to a collection bucket for draining the waterproof table planter.

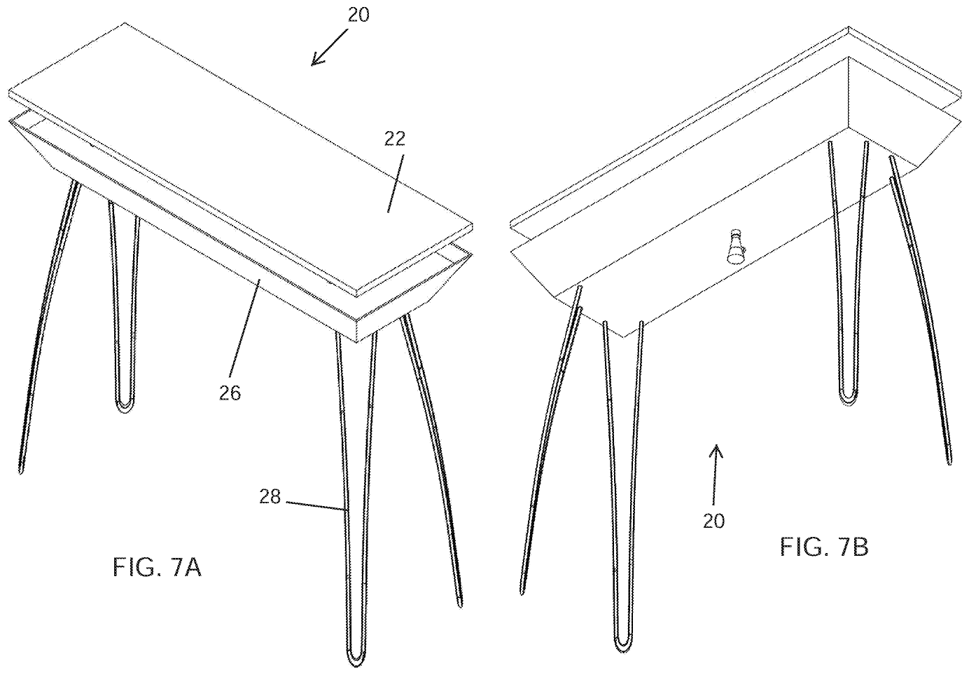

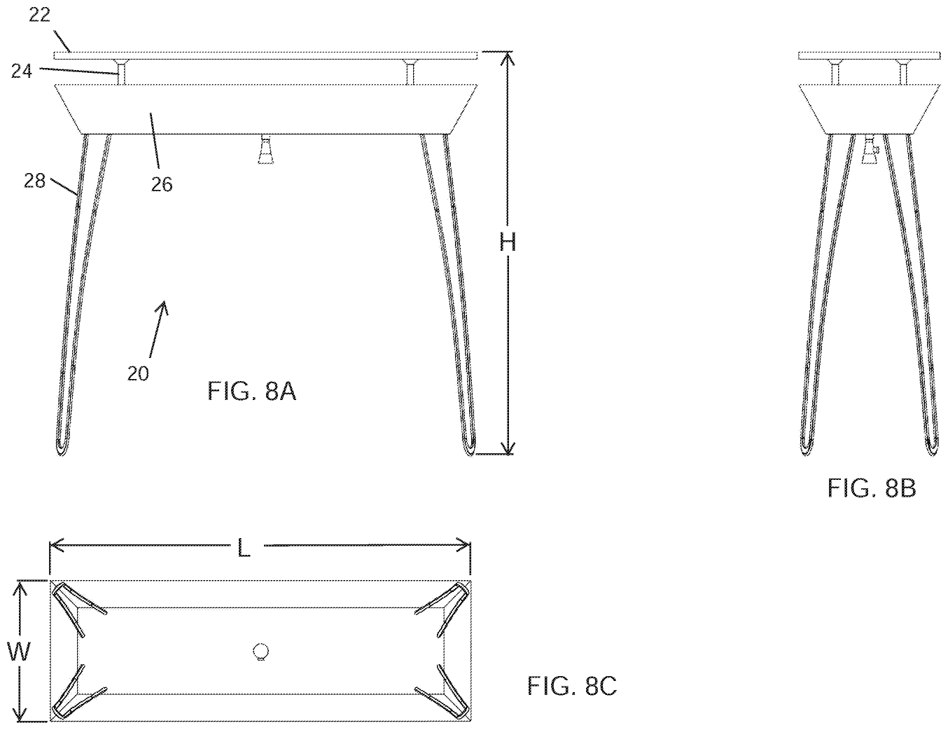

FIGS. 7A and 7B are perspective views of the elongated waterproof table planter 20 of FIG. 1 without plants, and FIG. 8A-8C are orthogonal views thereof. The elongated waterproof table planter 20 is shown with a rectangular tabletop 22 and planter 26 as seen in FIG. 8C having a length L significantly larger than a width W. The planter 26 is supported by relatively long legs 28 so that the entire assembly has a height H. In one embodiment, the length L is at least twice as long as the width W, and more preferably about three times as long as the width W. For example, the length L may be between 3-5 feet, with the width W approximately one third the length, or between 1-2 feet. The height H may be about the same as the length L, or slightly shorter. For instance, the height H is between 3-4 feet. These dimensions are well suited for positioning the table planter 20 along a wall for use as a side table.

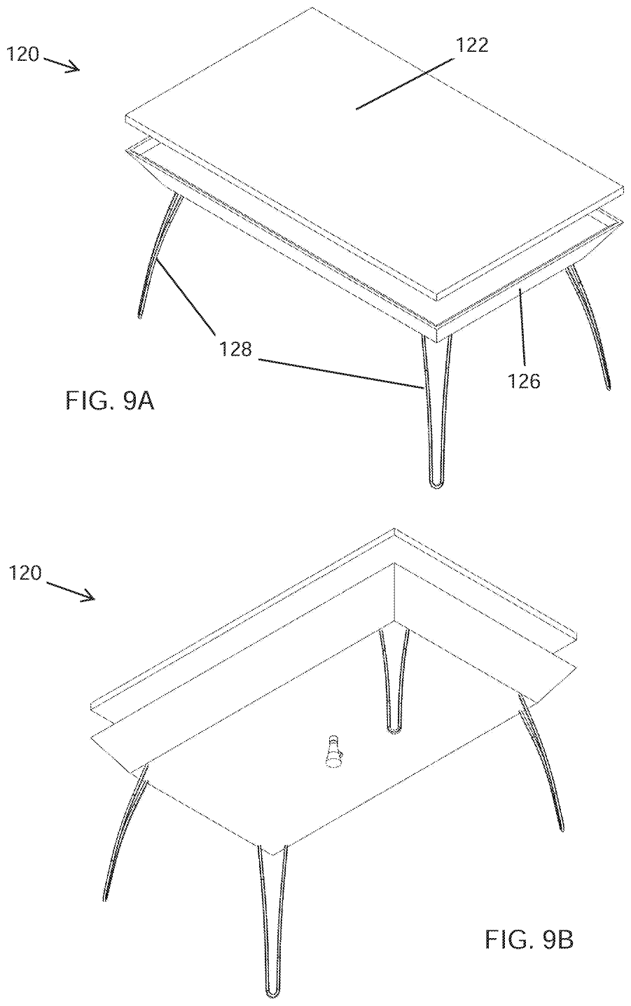

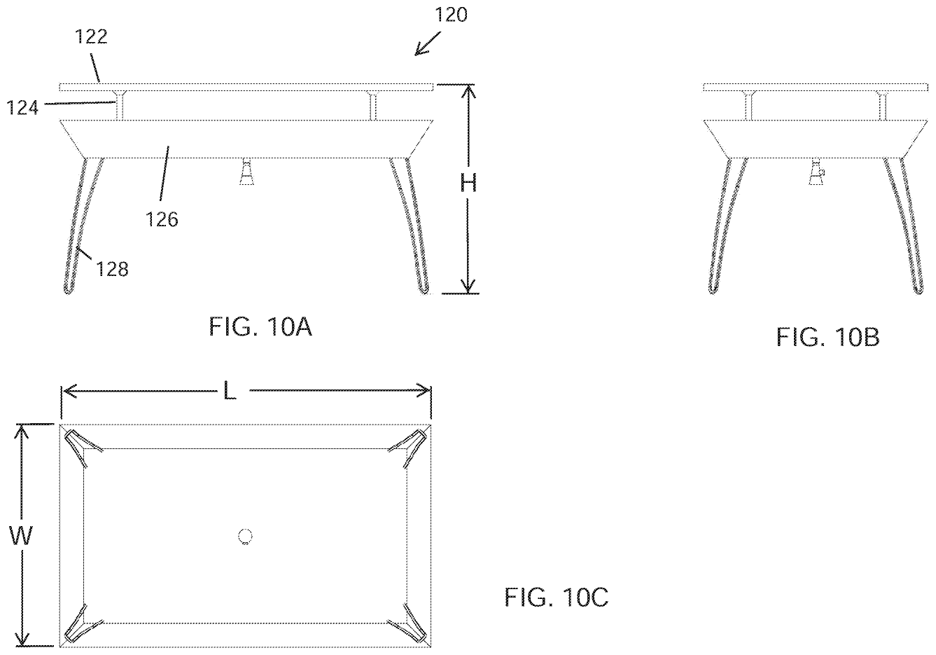

FIGS. 9A and 9B are perspective views of a coffee table version 120 of the waterproof table planter without plants, while FIG. 10A-10C are orthogonal views thereof. Aside from the shape and proportions, the coffee table planter 120 is constructed in the same manner as the table planter 20 described above. That is, the waterproof table planter 120 comprises a tabletop 122 supported on a plurality of columns 124 above a waterproof planter 126. The planter 126 is, in turn, supported above the ground by a plurality of generally vertical table legs 128.

The coffee table waterproof table planter 120 is shown with a rectangular tabletop 122 and planter 126 as seen in FIG. 10C having a length L larger than a width W. The planter 126 is supported by shorter legs 128 than the side table version so that the entire assembly has a height H. In one embodiment, the length L is about twice as long as the width W. For example, the length L may be between 3-4 feet, with the width W approximately one half the length, or between 1.5-2 feet. The height H may be about the same as the width W, or slightly shorter. For instance, the height H is between 1.5-2 feet. These dimensions are well suited for positioning the table planter 120 in the middle of a room such as in front of the couch for use as a coffee table.

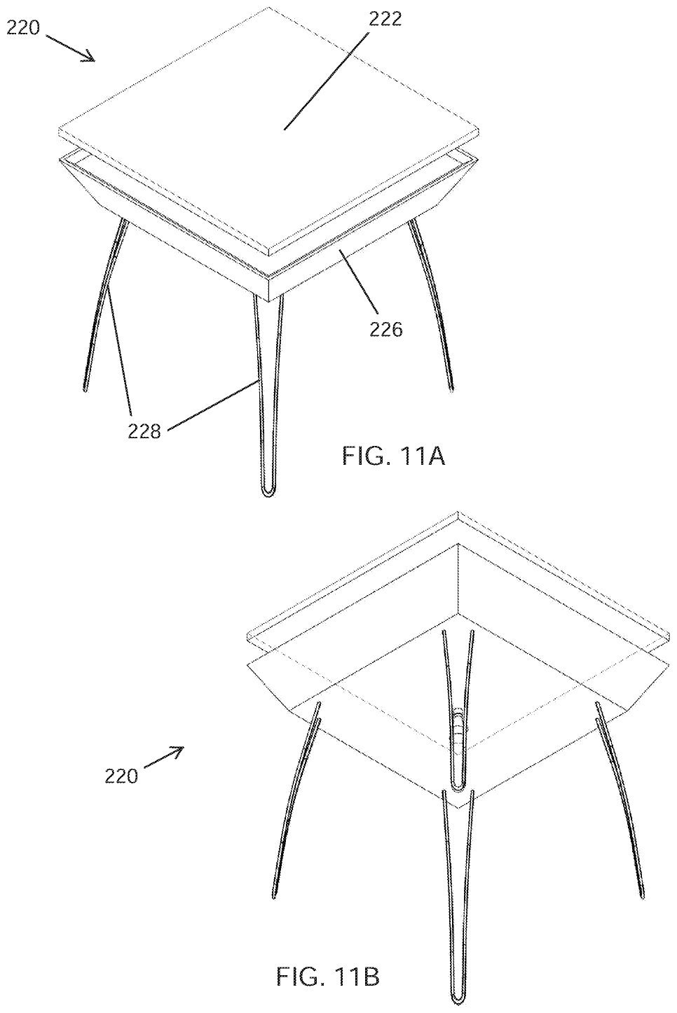

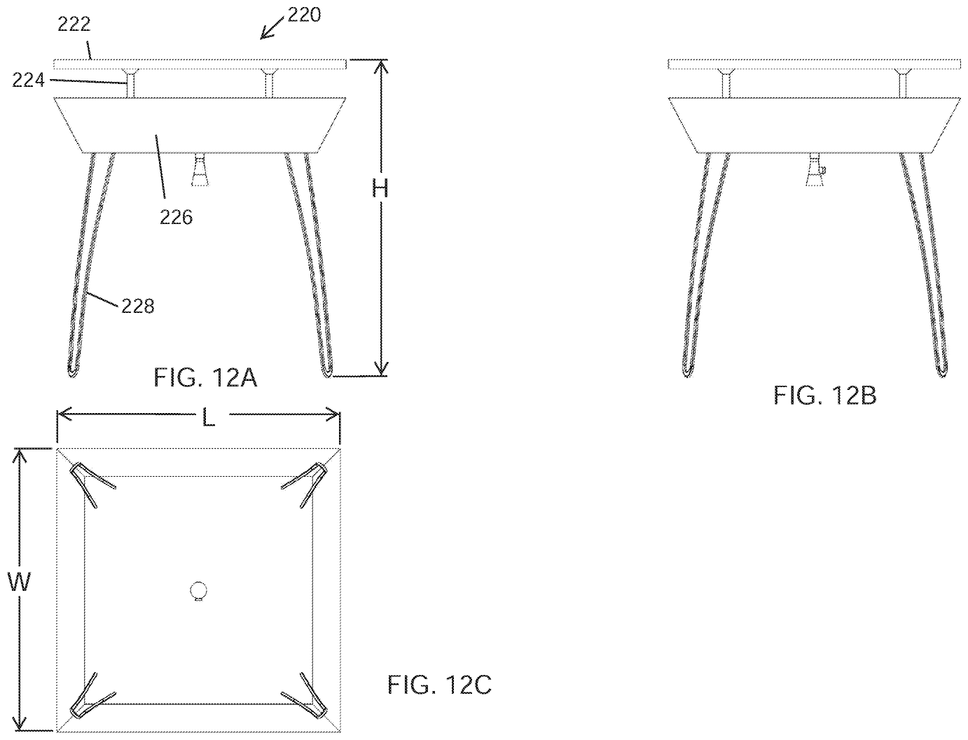

FIGS. 11A and 11B are perspective views of an end table version 220 of the waterproof table planter without plants, and FIG. 12A-12C are orthogonal views thereof. Again, aside from the shape and proportions, the coffee table planter 220 is constructed in the same manner as the table planter 20 described above. That is, the waterproof table planter 220 comprises a tabletop 222 supported on a plurality of columns 224 above a waterproof planter 226. The planter 226 is, in turn, supported above the ground by a plurality of generally vertical table legs 228.

The coffee table waterproof table planter 220 is shown with a square tabletop 222 and planter 226 as seen in FIG. 12C having a length L equal to a width W. The planter 226 is supported by shorter legs 228 than the side table version but longer than the coffee table version so that the entire assembly has a height H. For example, the length L and width W may be between 2-3 feet. The height H is preferably slightly greater than the length L and width W. For instance, the height H is between 2.5-3.5 feet. These dimensions are well suited for positioning the table planter 220 next to a bed or at the end of a couch for use as an end table.

Although the invention has been described and illustrated with a certain degree of particularity, it is understood that the present disclosure has been made only by way of example, and that numerous changes in the combination and arrangement of parts can be resorted to by those skilled in the art without departing from the scope of the invention, as hereinafter claimed.

It is claimed:

1. A waterproof table planter, comprising:
a planter having a lower main body having a floor and side walls on which rests a waterproof liner, the liner defining a trough having a floor and side walls for containing soil or other plant growth medium;
a tabletop spaced above the planter by a plurality of columns that are fixed to the floor of the liner, and further including seals between the columns and liner to prevent leakage therebetween; and
a plurality of generally vertical table legs fixed to an underside of the planter and supporting the planter horizontally above a ground surface.

2. The waterproof table planter of claim 1, wherein there are the same number of columns as table legs, and each column is located directly above a table leg and secured thereto.

3. The waterproof table planter of claim 2, wherein each table leg includes a vertical bolt extending upward through aligned holes in the lower main body and liner, wherein each column has a female threaded bore at a lower end that threateningly engages the vertical bolt in one of the table legs.

4. The waterproof table planter of claim 3, wherein each table leg further includes a horizontal flange at an upper end from which the vertical bolt extends upward, each horizontal flange having through holes for receiving fasteners for securing the table leg to an underside of the lower main body.

5. The waterproof table planter of claim 1, wherein the planter and tabletop have rectangular horizontal peripheries.

6. The waterproof table planter of claim 5, wherein the planter has a trapezoidal vertical section with the side walls of both the lower main body and liner angling outward from the respective floors.

7. The waterproof table planter of claim 1, wherein the liner comprises a hard plastic or acrylic.

8. The waterproof table planter of claim 1, further including a drain bulkhead extending through sealed holes in both the liner and lower main body, and a drain valve fastened to the drain bulkhead below the planter.

9. The waterproof table planter of claim 8, wherein the drain valve has a lower fastener to which a drain tube may be connected.

10. The waterproof table planter of claim 1, further including elastomeric members secured to top ends of the columns which support the tabletop and provide frictional resistance to horizontal sliding.

11. A waterproof table planter, comprising:
a waterproof planter having a floor and side walls and defining a trough for containing soil or other plant growth medium;
a tabletop spaced above the planter by a plurality of columns that are fixed to the floor of the planter, and further including seals between the columns and planter to prevent leakage therebetween;
a plurality of generally vertical table legs fixed to an underside of the planter and supporting the planter horizontally above a ground surface, each table leg being secured through the floor of the planter to one of the columns; and
a drain bulkhead extending through a sealed hole in the planter and a drain valve fastened to the drain bulkhead below the planter.

12. The waterproof table planter of claim 11, wherein each table leg includes a vertical bolt extending upward through a hole in the floor of the planter, wherein each column has a female threaded bore at a lower end that threateningly engages the vertical bolt in one of the table legs.

13. The waterproof table planter of claim 12, wherein each table leg further includes a horizontal flange at an upper end from which the vertical bolt extends upward, each horizontal flange having through holes for receiving fasteners for securing the table leg to an underside of the planter.

14. The waterproof table planter of claim 11, wherein the planter and tabletop have rectangular horizontal peripheries.

15. The waterproof table planter of claim 14, wherein the planter has a trapezoidal vertical section with the side walls angling outward from the floor.

16. The waterproof table planter of claim 11, wherein the planter comprises a lower main body having a floor and side walls on which rests a waterproof liner, the liner defining the trough.

17. The waterproof table planter of claim 16, wherein the liner comprises a hard plastic or acrylic.

18. The waterproof table planter of claim 17, wherein the planter has a trapezoidal vertical section with the side walls of both the lower main body and liner angling outward from the respective floors.

19. The waterproof table planter of claim 11, wherein the drain valve has a lower fastener to which a drain tube may be connected.

20. The waterproof table planter of claim 11, further including elastomeric members secured to top ends of the columns which support the tabletop and provide frictional resistance to horizontal sliding.
